(19) United States
(12) Patent Application Publication
(10) Pub. No.: US 2026/0252001 A1
(43) Pub. Date: Aug. 27, 2026

(54) DEVELOPER CARRYING MEMBER AND METHOD FOR MANUFACTURING THE SAME

(71) Applicant: KYOCERA Document Solutions Inc., Osaka (JP)

(72) Inventors: Shoji ITSUMI, Osaka (JP); Makoto SHISHIDO, Osaka (JP); Yukimasa WATANABE, Osaka (JP); Kazuaki EZURE, Osaka (JP)

(73) Assignee: KYOCERA Document Solutions Inc., Osaka (JP)

(21) Appl. No.: 19/545,670

(22) Filed: Feb. 20, 2026

(30) Foreign Application Priority Data
Feb. 25, 2025 (JP) 2025-028050

(51) Int. Cl. G03G 15/09

(52) U.S. Cl. CPC G03G 15/0928; G03G 2215/0861; G03G 2215/0863

(57) ABSTRACT

A developer carrying member includes a shaft, a magnet, a sleeve, a flange and an adhesive. The flange includes a fitting portion. The fitting portion includes a first support portion, a second support portion and a groove portion. The adhesive is disposed in the groove portion. When accuracy of runout required during rotation of the sleeve is R (μm), the length of the sleeve is L (mm), a distance from an end of the first support portion to an end of the second support portion is S (mm) and each of outside diameters of the first support portion and the second support portion is D (mm), the value of the R is 50, and R>L/(S×D)×1.9 is satisfied.

### INCORPORATION BY REFERENCE

This application is based upon and claims the benefit of priority from the corresponding Japanese Patent Application No. 2025-028050 (filed on February 25, 2025), the entire contents of which are incorporated herein by reference.

### BACKGROUND

The present disclosure relates to a developer carrying member and a method for manufacturing such a developer carrying member.

An electrophotographic image forming apparatus includes a development device. In the development device, a developer carrying member is installed. The developer carrying member is rotated while carrying a developer, and supplies the developer to an image carrying member.

A conventional developer carrying member includes a cylindrical sleeve, a magnet which is disposed inside the sleeve, a flange which is fixed to an end opening of the sleeve and the like. A developer is carried on the outer circumferential surface of the sleeve.

### SUMMARY

A developer carrying member according to a first aspect of the present disclosure includes a shaft, a magnet, a sleeve, a flange and an adhesive. The shaft extends in a predetermined direction. The magnet is fixed to the outer circumferential surface of the shaft. The sleeve is cylindrical with the shaft being a center axis and carries a developer on an outer circumferential surface. The flange is fixed to an end opening of the sleeve in the predetermined direction, is rotatably supported to the shaft and is rotated around the center axis together with the sleeve. The adhesive bonds the sleeve and the flange. The flange includes a cylindrical fitting portion that is fitted into the sleeve through the end opening. The fitting portion includes a first support portion, a second support portion and a groove portion. The first support portion is in contact with the inner circumferential surface of the sleeve. The second support portion has the same outside diameter as the outside diameter of the first support portion, and is in contact with the inner circumferential surface of the sleeve in a position on a side of the end opening relative to the first support portion. The groove portion is formed between the first support portion and the second support portion in the predetermined direction, and is recessed in a radial direction relative to each of outer circumferential surfaces of the first support portion and the second support portion. The adhesive is disposed in the groove portion. When accuracy of runout required during rotation of the sleeve is R (μm), the length of the sleeve in the predetermined direction is L (mm), a distance in the predetermined direction from an end of the first support portion on a side opposite to the side of the end opening to an end of the second support portion on the side of the end opening is S (mm) and each of the outside diameters of the first support portion and the second support portion is D (mm), the value of the R is 50, and R>L/(S×D)×1.9 is satisfied.

A method for manufacturing a developer carrying member according to a second aspect of the present disclosure is a method for manufacturing the developer carrying member described above, the method includes: a step of applying the adhesive to the groove portion; and a step of inserting the fitting portion into the sleeve through the end opening in a state where the adhesive has been applied to the groove portion and each of the outside diameters of the first support portion and the second support portion is equal to or greater than the inside diameter of the sleeve before the fitting portion is inserted.

### BRIEF DESCRIPTION OF THE DRAWINGS

FIG. 1 is a schematic view of an image forming apparatus in an embodiment;

FIG. 2 is a schematic view of a development device in the embodiment and an area therearound;

FIG. 3 is a schematic view of the development device in the embodiment;

FIG. 4 is a plan view when a development roller in the embodiment is viewed from the outside in a radial direction;

FIG. 5 is a cross-sectional view taken along line A-A′ in FIG. 4;

FIG. 6 is a diagram of only a flange in a first embodiment;

FIG. 7 is an enlarge view of a groove portion of the flange in the first embodiment and an area therearound;

FIG. 8 is an enlarge cross-sectional view (cross-sectional view corresponding to a part indicated by an arrow B in FIG. 5) of the fitting part of the flange and a sleeve in the first embodiment;

FIG. 9 is a diagram of only a flange in a second embodiment;

FIG. 10 is an enlarge view of a groove portion of the flange in the second embodiment and an area therearound;

FIG. 11 is an enlarge cross-sectional view (cross-sectional view corresponding to the part indicated by the arrow B in FIG. 5) of the fitting part of the flange and a sleeve in the second embodiment;

FIG. 12 is a diagram of only a flange in a variation; and

FIG. 13 is a diagram showing the results of an experiment which was performed for checking the effects of the embodiments.

### DETAILED DESCRIPTION

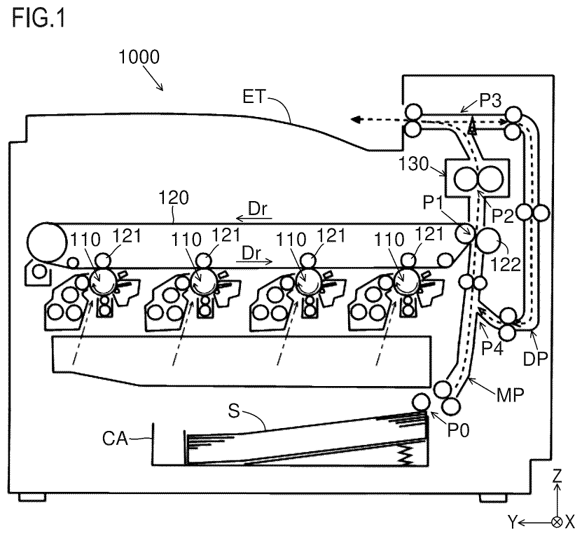

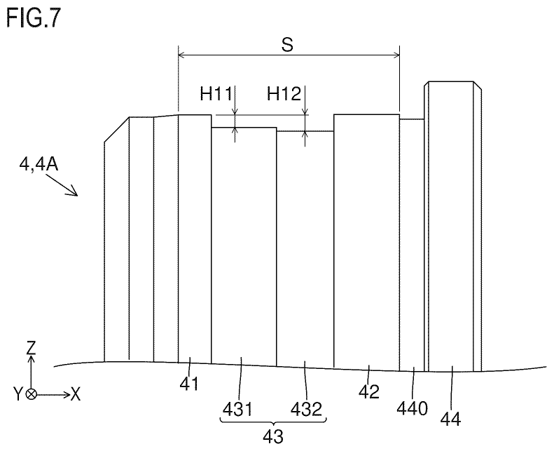

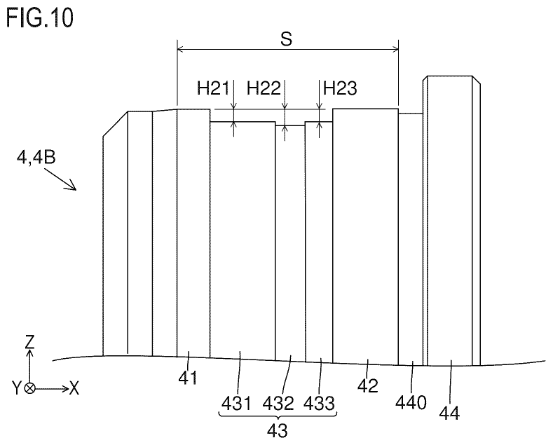

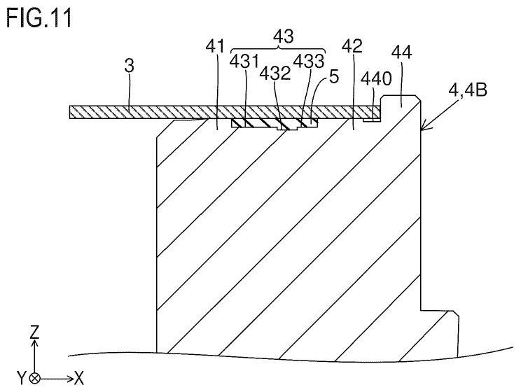

A development roller 10 in the present embodiment will be described below with reference to FIGS. 1 to 11. The development roller 10 corresponds to a “developer carrying member”.

The development roller 10 is installed in an image forming apparatus 1000. Specifically, the development roller 10 is installed in a development device 100, and the development device 100 is installed in the image forming apparatus 1000.

The image forming apparatus 1000 is a tandem color laser printer. However, the image forming apparatus 1000 is not limited to the tandem color laser printer. The image forming apparatus 1000 may also be a monochrome printer, a multifunctional peripheral, a facsimile machine or the like.

In drawings referred to in the following description, for ease of understanding, an XYZ orthogonal coordinate system is shown. A Z direction is a vertical direction, and is an up/down direction in the image forming apparatus 1000. A flat surface on which the image forming apparatus 1000 is installed is perpendicular to the Z direction. The direction of the arrow of the Z axis is an upward direction, and a direction opposite thereto is a downward direction.

An X direction is one direction of horizontal directions, and a Y direction is other direction of the horizontal directions. For example, the X direction corresponds to a forward/backward direction in the image forming apparatus 1000. The Y direction corresponds to a left/right direction in the image forming apparatus 1000.

### <1. Overall Configuration of Image Forming Apparatus>

As shown in FIG. 1, the image forming apparatus 1000 includes a main conveyance path MP. The image forming apparatus 1000 also includes a sheet cassette CA. The sheet cassette CA is removable from the main body of the image forming apparatus 1000. The sheet cassette CA stores a sheet S used in a print job. The sheet S is supplied from the sheet cassette CA to the main conveyance path MP. The main conveyance path MP passes from the supply position P0 of the sheet S through a transfer position P1 and a fixing position P2 in this order to reach an ejection tray ET.

In the print job, the sheet S in the sheet cassette CA is supplied from the supply position P0 to the main conveyance path MP, and the supplied sheet S is conveyed along the main conveyance path MP. The image forming apparatus 1000 prints an image on the sheet S being conveyed. In other words, the image forming apparatus 1000 transfers toner images to the sheet S being conveyed. In the transfer position P1, transfer processing is performed on the toner images to the sheet S being conveyed. In the fixing position P2, fixing processing is performed on the toner images on the sheet S.

The image forming apparatus 1000 includes image formation units 110 of four colors of cyan, magenta, yellow and black, Each of the image formation units 110 uses the toner of the corresponding color to form a toner image. Attention is focused on one of the image formation units 110, and the configuration thereof will be described below. The basic configurations of the image formation units 110 are the same as each other. Hence, the description of the configurations of the other image formation units 110 is omitted because the following description can be used therefor.

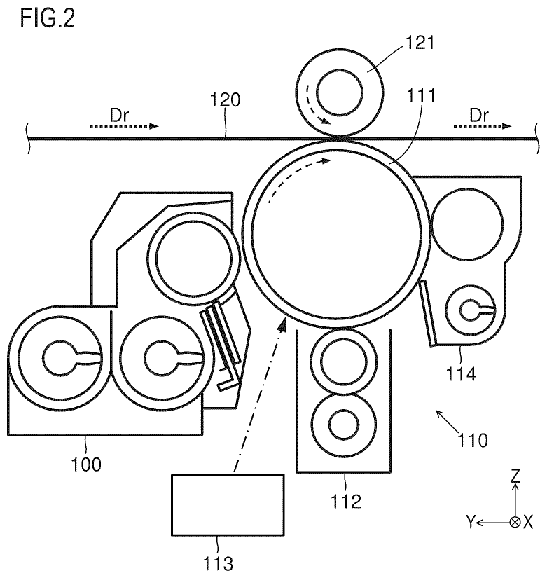

As shown in FIG. 2, the image formation unit 110 includes the development device 100. The image formation unit 110 includes, in addition to the development device 100, a photosensitive drum 111, a charging device 112, an exposure device 113 and a cleaning device 114.

When image formation is performed by the image formation unit 110, the photosensitive drum 111 is rotated. The charging device 112 charges the outer circumferential surface of the photosensitive drum 111. The exposure device 113 exposes the outer circumferential surface of the photosensitive drum 111 to form an electrostatic latent image on the outer circumferential surface of the photosensitive drum 111. Then, the development device 100 supplies the toner to the outer circumferential surface of the photosensitive drum 111, and develops the electrostatic latent image into the toner image. The cleaning device 114 removes the toner left on the outer circumferential surface of the photosensitive drum 111.

As shown in FIG. 1, the image forming apparatus 1000 includes an intermediate transfer belt 120. The intermediate transfer belt 120 is a seamless belt. The intermediate transfer belt 120 is brought into contact with the outer circumferential surface of the photosensitive drum 111, and is rotated (revolved) in a direction indicated by an arrow Dr in this state.

The image forming apparatus 1000 includes a plurality of primary transfer roller 121. The primary transfer rollers 121 are assigned to the colors of cyan, magenta, yellow and black, respectively. The primary transfer rollers 121 are disposed on the side of the inner circumferential surface of the intermediate transfer belt 120. Each of the primary transfer rollers 121 is disposed through the intermediate transfer belt 120 opposite the photosensitive drum 111 which carries the toner image of the corresponding color.

The image forming apparatus 1000 includes a secondary transfer roller 122. The secondary transfer roller 122 is pressed against the outer circumferential surface of the intermediate transfer belt 120 in the transfer position P1. The secondary transfer roller 122 forms a transfer nip between the intermediate transfer belt 120 and the secondary transfer roller 122. The main conveyance path MP passes through the transfer nip.

In the print job, the sheet S is conveyed toward the transfer position P1 (that the transfer nip). The sheet S being conveyed is passed through the transfer nip.

The toner images are primarily transferred from the photosensitive drums 111 the intermediate transfer belt 120. The intermediate transfer belt 120 is rotated while carrying the toner images on the outer circumferential surface. While the sheet S is being passed through the transfer nip, the sheet S makes contact with the outer circumferential surface of the intermediate transfer belt 120. In this way, the toner images are secondarily transferred to the sheet S which is being passed through the transfer nip.

Various types of rotation members such as the photosensitive drums 111 in the image formation units 110 are rotated around axes which extend in the X direction. Likewise, the primary transfer rollers 121, the secondary transfer roller 122 and the like are rotated around axes which extend in the X direction.

The image forming apparatus 1000 includes a fixing unit 130. The fixing unit includes a heating roller and a pressure roller. The fixing unit 130 is disposed in the fixing position P2. The heating roller incorporates a heater. The pressure roller is pressed against the heating roller. The heating roller and the pressure roller are pressed against each other to form a fixing nip in the fixing position P2.

In the print job, the sheet S subjected to the transfer processing of the toner images is passed through the fixing position P2. In other words, the sheet S is sandwiched in the fixing nip between the heating roller and the pressure roller. The fixing unit 130 heats the sheet S which is being passed through the fixing position P2. The sheet S is pressurized in the fixing position P2. The fixing unit 130 heats and pressurizes the sheet S subjected to the transfer processing of the toner images to fix the toner images on the sheet S. The sheet S subjected to the fixing processing is ejected to the ejection tray ET.

The image forming apparatus 1000 includes a conveyance unit the symbol of which is omitted. The conveyance unit includes a conveyance roller pair. The number of conveyance roller pairs installed is not particularly limited.

The conveyance roller pair includes a pair of rollers. The pair of rollers includes a conveyance nip between the rollers. The conveyance roller pair is rotated to convey the sheet S which has entered the conveyance nip. The conveyance unit conveys the sheet S along the main conveyance path MP. The conveyance unit also conveys the sheet S along a double-sided printing conveyance path DP which will be described later.

The image forming apparatus 1000 can perform a double-sided printing job for printing toner images on both surfaces of the sheet S in addition to a single-sided printing job for printing toner images on only one surface of the sheet S. In order to perform the double-sided printing job, the image forming apparatus 1000 includes the double-sided printing conveyance path DP.

The double-sided printing conveyance path DP branches from the main conveyance path MP in a branch position P3 on a downstream side in a sheet conveyance direction relative to the fixing position P2 in the main conveyance path MP. The double-sided printing conveyance path DP merges into the main conveyance path MP in a merging position P4 on an upstream side in the sheet conveyance direction relative to the transfer position P1 in the main conveyance path MP.

When the job to be performed is the single-sided printing job, the sheet S is passed through the transfer nip only once, and the transfer processing is performed once on the sheet S which is being passed through the transfer nip. Then, after the first transfer processing, the sheet S is ejected to the ejection tray ET without being processed.

When the job to be performed is the double-sided printing job, the transfer processing is performed once on each of the front and back surfaces of the sheet S, and thus the sheet S is passed through the transfer nip twice. Specifically, when the sheet S is passed through the transfer nip for the first time, the transfer processing is performed on one surface of the sheet S. After the first transfer processing, the sheet S is switched back after the back end of the sheet S is passed through the branch position P3 and before the sheet S is completely ejected to the ejection tray ET. In this way, the sheet S is drawn into the double-sided printing conveyance path DP from the back end.

Thereafter, the sheet S is conveyed along the double-sided printing conveyance path DP. Then, the sheet S in the double-sided printing conveyance path DP is returned from the merging position P4 to the main conveyance path MP. The sheet S which has been returned to the main conveyance path MP is conveyed along the main conveyance path MP, and is passed through the transfer nip again. Here, the orientation of the front and back surfaces of sheet S is reversed relative to the orientation thereof when the sheet S is passed through the transfer nip last time. In this way, when the sheet S is passed through the transfer nip for the second time, the transfer processing is performed on the other surface opposite to the one surface of the sheet S.

### <2. Configuration of Development Device>

Attention is focused on one of the development devices 100, and the configuration thereof will be described below. The basic configurations of the development devices 100 are the same as each other. Hence, the description of the configurations of the other development devices 100 is omitted because the following description can be used therefor.

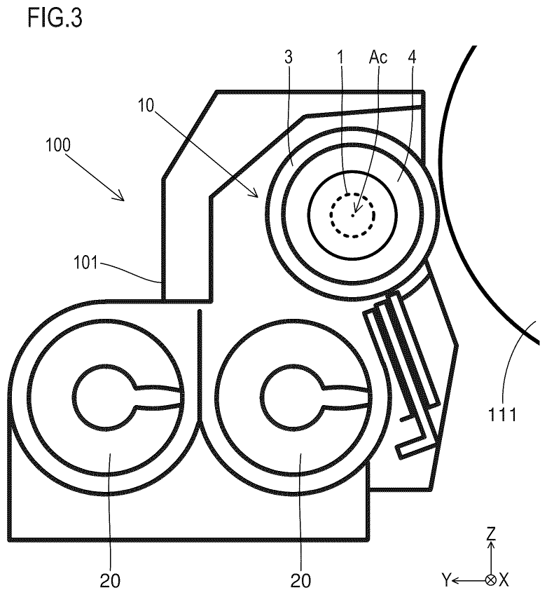

As shown in FIG. 3, the development device 100 includes a development container 101. The development container 101 stores a developer which includes a toner. The developer is, for example, a magnetic one-component developer including a magnetic toner. The development device 100 supplies the toner stored in the development container 101 to the outer circumferential surface of the photosensitive drum 111 (that is, the electrostatic latent image).

The development device 100 includes the development roller 10. The development roller 10 is disposed inside the development container 101. The development roller 10 is supported to be rotatable around an axis extending in the X direction. Only an outer circumferential part of the development roller 10 which includes the outer circumferential surface is rotatable around the axis extending in the X direction.

In the development roller 10, a part of the outer circumferential surface is exposed to the outside of the development container 101. Specifically, the development container 101 includes an opening (the symbol of which is omitted) in a position opposite the photosensitive drum 111. The part of the outer circumferential surface of the development roller 10 is exposed from the opening of the development container 101. In this way, the outer circumferential surface of the development roller 10 and the outer circumferential surface of the photosensitive drum 111 are opposite each other. The development roller 10 carries the toner on the outer circumferential surface, and supplies the toner to the electrostatic latent image on the outer circumferential surface of the photosensitive drum 111.

The development device 100 includes two stirring screws 20. The stirring screws 20 are disposed inside the development container 101. Each of the stirring screws 20 is supported to be rotatable around an axis extending in the X direction. Each of the stirring screws 20 has a structure in which a blade is wound spirally around its rotation shaft. The stirring screws 20 are rotated to stir the developer.

### <3. Configuration of Development Roller>

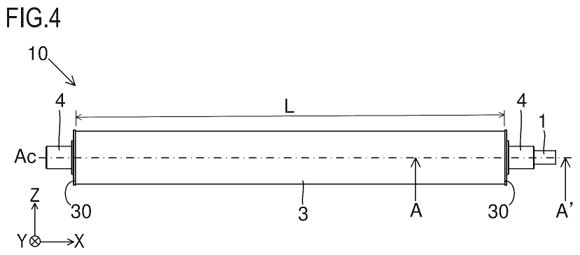

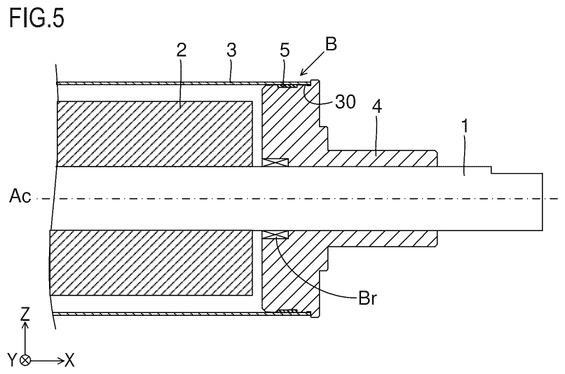

The configuration of the development roller 10 will be described in detail below with reference to FIGS. 4 and 5. In the following description, the X direction in which the center axis Ac (rotation axis) of the development roller 10 extends is referred to as an axial direction, and a direction which is perpendicular to the center axis Ac is referred to as a radial direction. In the axial direction, a direction which approaches the center of the development roller 10 is referred to as “inward in the axial direction”, and a direction away from the center of the development roller 10 is referred to as “outward in the axial direction”. In the radial direction, a direction which approaches the center axis Ac is referred to as “inward in the radial direction”, and a direction away from the center axis Ac is referred to as “outward in the radial direction”.

The development roller 10 includes a shaft 1. The shaft 1 is a round bar, and extends in the axial direction. In other words, the axial direction corresponds to a “predetermined direction”. The center axis of the shaft 1 is the center axis Ac of the development roller 10. The shaft 1 has a D-cut surface at one end in the axial direction, and is fixed so as not to rotate.

The development roller 10 includes a magnet 2. The magnet 2 is fixed to the outer circumferential surface of the shaft 1. The magnet 2 extends in the axial direction. The magnet 2 includes a plurality of magnetic poles in the circumferential direction of the shaft 1.

The development roller 10 includes a sleeve 3. The sleeve 3 is made of aluminum in order to suppress an increase in cost. The sleeve 3 is cylindrical with the shaft 1 being a center axis. The center axis Ac of the development roller 10 matches with the center axis of the sleeve 3. The shaft 1 is inserted into the sleeve 3. In other words, a state where the magnet 2 is disposed inside the sleeve 3 is reached. In this state, the inner circumferential surface of the sleeve 3 and the magnet 2 are opposite each other with a distance therebetween in the radial direction. The outer circumferential surface of the sleeve 3 is the outer circumferential surface of the development roller 10.

The sleeve 3 carries the developer (toner) on the outer circumferential surface The developer is carried on the outer peripheral surface of the sleeve 3 by the magnetic force of the magnet 2, and a magnetic brush is formed on the outer circumferential surface of the sleeve 3. The sleeve 3 is rotated while carrying the developer on the outer circumferential surface, and supplies the developer to the photosensitive drum 111.

The development roller 10 includes a flange 4. The flange 4 is made of aluminum in order to suppress an increase in cost. The flange 4 is fixed to an end opening 30 of the sleeve 3 in the axial direction.

The flange 4 includes a bearing Br. The inner ring of the bearing Br is fixed to the shaft 1, and the outer ring of the bearing Br is fixed to the flange 4. In this way, the flange 4 is rotatably supported to the shaft 1. The flange 4 is rotated around the center axis Ac (that is, around the center axis of the shaft 1) together with the sleeve 3.

The flanges 4 are fixed to one end opening 30 of the sleeve 3 in the axial direction, and to the other end opening 30 in the axial direction, respectively. In other words, the two flanges 4 are provided.

The shaft 1 penetrates the flange 4 on one side in the axial direction. In this way, the end of the shaft 1 which has the D-cut surface protrudes to the outside of the sleeve 3. The end of the shaft 1 which protrudes to the outside of the sleeve 3 is clamped, and thus the shaft 1 cannot be rotated. The flange 4 on the other side is coupled to a motor (not shown). A driving force is transmitted from the motor to the flange 4 on the other side, and thus the flange 4 on the other side is rotated around the center axis Ac (that is, around the center axis of the shaft 1).

The structures of the flange 4 on one side and the flange 4 on the other side are the same as each other except that a coupling portion for the motor is provided. Hence, for convenience, the same symbol is used for the flange 4 on one side and the flange 4 on the other side.

The development roller 10 includes an adhesive 5. The adhesive 5 bonds the sleeve 3 and the flange 4. The type of adhesive 5 is not particularly limited. For example, the adhesive 5 is anaerobic. The adhesive 5 does not need to be anaerobic.

### <4. Structure of Flange>

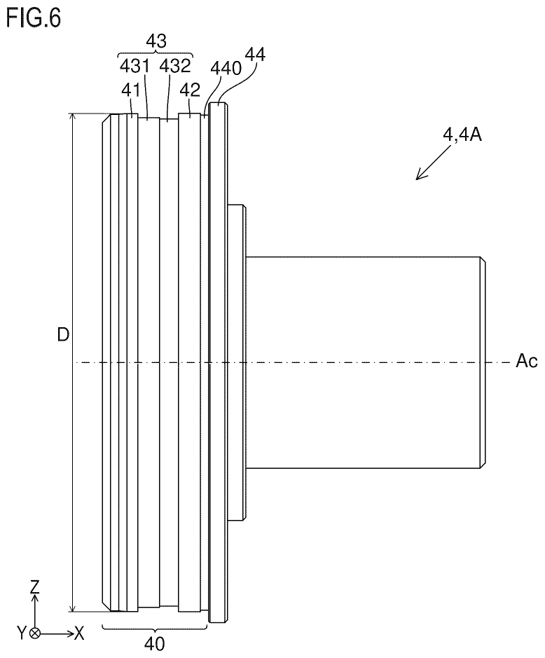

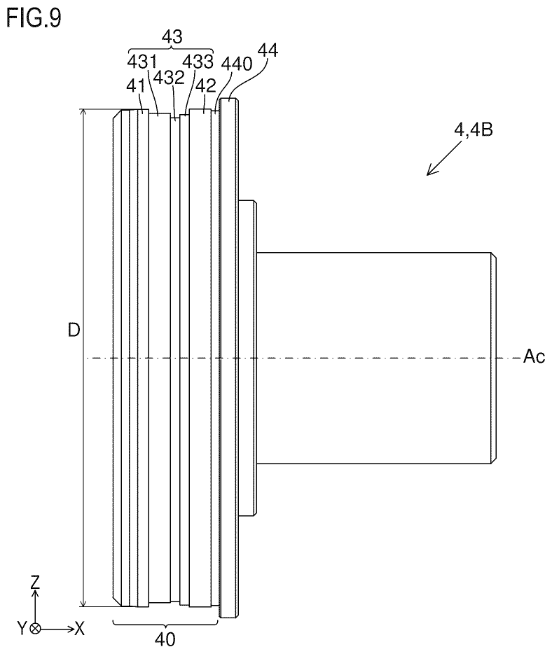

Attention is focused on the flange 4 on one side, and the structure thereof be described below with reference to FIGS. 6 to 8 (first embodiment) and FIG. 9 to 11 (second embodiment). The structures of the flange 4 on one side and the flange 4 on the other side are the same as each other except that the coupling portion for the motor is provided. Hence, the description of the structure of the flange 4 on the other side is omitted because the following description can be used therefor.

The flange 4 includes a fitting portion 40. The fitting portion 40 is cylindrical The fitting portion 40 is a part which is disposed in the sleeve 3. The fitting portion 40 is fitted into the sleeve 3 through the end opening 30 of the sleeve 3. The fitting portion 40 is inserted into the sleeve 3 from outward in the axial direction. The fitting portion 40 is fitted into the sleeve 3, and thus the flange 4 is fixed to the end opening 30 of the sleeve 3.

The maximum outside diameter of the fitting portion 40 is equal to or greater than the inside diameter of the sleeve 3 before the fitting portion 40 is inserted. Hence, the fitting portion 40 is press-fitted into the sleeve 3 through the end opening 30. Although details will be described later, the outside diameters of a first support portion 41 and a second support portion 42 correspond to the maximum outside diameter of the fitting portion 40. A groove portion 43 is formed in the fitting portion 40, and thus a part of the fitting portion 40 which has the maximum outside diameter is divided into the first support portion 41 and the second support portion 42.

The flange 4 includes a brim portion 44. The brim portion 44 is formed on the side of the end opening 30 relative to the fitting portion 40 (specifically, the second support portion 42 which will be described later). In other words, the brim portion 44 is formed outward in the axial direction relative to the fitting portion 40. The brim portion 44 protrudes outward in the axial direction relative to the fitting portion 40 over the entire circumference in the circumferential direction of the flange 4.

The brim portion 44 has a circular outer shape when viewed in the axial direction. outside diameter of the brim portion 44 is greater than the maximum outside diameter of the fitting portion 40. Hence, the fitting portion 40 is inserted into the sleeve 3 until the surface of the brim portion 44 which faces inward in the axial direction (hereinafter referred to as the inward surface in the axial direction) makes contact with the surface of the sleeve 3 which faces outward in the axial direction (hereinafter referred to as the end surface in the axial direction). In other words, in a state where the flange 4 is fitted in the sleeve 3, the end surface of the sleeve 3 in the axial direction is in contact with the inward surface of the brim portion 44 in the axial direction. In this way, it is possible to suppress a displacement of the sleeve 3 in the axial direction.

The fitting portion 40 includes the first support portion 41. The first support portion 41 is in contact with the inner circumferential surface of the sleeve 3. The fitting portion 40 includes the second support portion 42. The second support portion 42 is a part of the fitting portion 40 which is located outward in the axial direction relative to the first support portion 41. The outside diameter of the second support portion 42 is the same as that of the first support portion 41. Hence, the second support portion 42 is in contact with the inner circumferential surface of the sleeve 3 on the side of the end opening 30 of the sleeve 3 relative to the first support portion 41 together with the first support portion 41.

The first support portion 41 and the second support portion 42 are the parts of fitting portion 40 which have the largest outer diameter. The outside diameters of the first support portion 41 and the second support portion 42 (that is, the maximum outside diameter of the fitting portion 40) are equal to or greater than the inside diameter of the sleeve 3. Hence, the fitting portion 40 is press-fitted into the sleeve 3.

The fitting portion 40 includes a brim side groove portion 440. The brim side groove portion 440 is formed between the second support portion 42 and the brim portion 44 in the axial direction. The brim side groove portion 440 is a part which is recessed inward in the radial direction relative to the outer circumferential surface of the second support portion 42. In other words, the brim side groove portion 440 has an outside diameter smaller than the second support portion 42. The brim side groove portion 440 is continuous without a break in the circumferential direction of the fitting portion 40. The brim portion 44 forms one of inner side surfaces of the brim side groove portion 440 in the axial direction.

The brim side groove portion 440 is provided in the fitting portion 40, and thus the fitting portion 40 can be inserted into the sleeve 3 until the end surface of the sleeve 3 in the axial direction makes contact with the inward surface of the brim portion 44 in the axial direction. In this way, it is possible to more reliably bring the end surface of the sleeve 3 in the axial direction into intimate contact with the inward surface of the brim portion 44 in the axial direction. The end surface of the sleeve 3 in the axial direction is in intimate contact with the inward surface of the brim portion 44 in the axial direction, and thus the sleeve 3 is unlikely to be inclined relative to the center axis Ac (that is, the center axis of the flange 4). Consequently, it is possible to suppress the runout of the sleeve 3 during the rotation of the development roller 10.

The fitting portion 40 includes the groove portion 43. The groove portion 43 is formed between the first support portion 41 and the second support portion 42 in the axial direction. The groove portion 43 is a part which is recessed inward in the radial direction relative to the outer circumferential surfaces of the first support portion 41 and the second support portion 42. In other words, the groove portion 43 is a part which has a smaller outside diameter than the first support portion 41 and the second support portion 42. The groove portion 43 is adjacent to the first support portion 41 on the inward side in the axial direction, and is adjacent to the second support portion 42 on the outward side in the axial direction. The groove portion 43 is continuous without a break in the circumferential direction of the fitting portion 40. The bottom surface of the groove portion 43 in the inner surface of the groove portion 43 is a surface which faces outward in the radial direction.

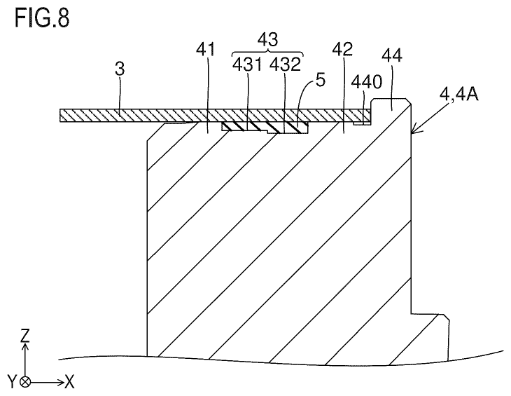

Here, the adhesive 5 is disposed in the groove portion 43 (see FIGS. 8 and 1 Specifically, the adhesive 5 is disposed between the inner circumferential surface of the sleeve 3 and the bottom surface of the groove portion 43 in the radial direction. In other words, the adhesive 5 is disposed between the sleeve 3 and the flange 4 in the radial direction. The adhesive 5 is cured between the sleeve 3 and the flange 4 in the radial direction, and thus the flange 4 is fixed to the sleeve 3.

The configuration described above is common to the first embodiment and the second embodiment. The first embodiment differs from the second embodiment in the shape of the groove portion 43. The groove portions 43 in the first and second embodiments will be described below. In the following description, it is likely that the flange 4 (see FIGS. 6 to 8) in the first embodiment is identified with a symbol 4A, and the flange 4 (see FIGS. 9 to 11) in the second embodiment is identified with a symbol 4B, and thus the flanges are distinguished.

### <4.1. Groove Portion in First Embodiment>

In the first embodiment, as shown in FIGS. 6 to 8, the groove portion 43 includes the first groove portion 431 and the second groove portion 432. The first g roove portion 431 and the second groove portion 432 are continuously formed in this order from the side of the first support portion 41 (that is, the inward side in the axial direction) to the side of the second support portion 42 (that is, the outward side in the axial direction) in the axial direction. In other words, the first groove portion 431 is adjacent to the first support portion 41 in the axial direction on the inward side in the axial direction. The second groove portion 432 is adjacent to the second support portion 42 in the axial direction on the outward side in the axial direction. The first groove portion 431 and the second groove portion 432 are adjacent to each other in the axial direction.

In the first embodiment, a height in the radial direction from the bottom surface of the groove portion 43 to the outer circumferential surfaces of the first support portion 41 and the second support portion 42 differs depending on the location. In the following description, it is assumed that the height in the radial direction from the bottom surface of the first groove portion 431 to the outer circumferential surfaces of the first support portion 41 and the second support portion 42 is H11, and the height in the radial direction from the bottom surface of the second groove portion 432 to the outer circumferential surfaces of the first support portion 41 and the second support portion 42 is H12.

In the first embodiment, the groove portion 43 is formed such that the height is higher than the height H11. In other words, a depth in the radial direction from the outer circumferential surfaces of the first support portion 41 and the second support portion 42 to the bottom surface of the second groove portion 432 (the depth corresponds to the height H12) is deeper than a depth in the radial direction from the outer circumferential surfaces of the first support portion 41 and the second support portion 42 to the bottom surface of the first groove portion 431 (the depth corresponds to the height H11).

In the first embodiment, the height from the lowest bottom surface of the groove portion 43 (that is, the deepest part of the groove portion 43) to the outer circumferential surfaces of the first support portion 41 and the second support portion 42 is set equal to or greater than 0.10 mm and equal to or less than 0.45 mm. Here, the deepest part of the groove portion 43 is the bottom surface of the second groove portion 432. Hence, the height H12 is equal to or greater than 0.10 mm and equal to or less than 0.45 mm.

The optimum value of the height (that is, the height H12) from the lowest bottom surface of the groove portion 43 to the outer circumferential surfaces of the first support portion 41 and the second support portion 42 varies depending on the type of adhesive 5. For example, when an anaerobic adhesive is used as the adhesive 5, the height from the lowest bottom surface of the groove portion 43 to the outer circumferential surfaces of the first support portion 41 and the second support portion 42 is set equal to or greater than 0.10 mm and equal to or less than 0.45 mm.

In the first embodiment, the groove portion 43 is formed in the fitting portion 40 and the adhesive 5 is disposed in the groove portion 43. In this way, in the first embodiment, when the development roller 10 is manufactured, it is possible to suppress spilling of the adhesive 5 out on the outer circumferential surface of the sleeve 3. A specific example will be described below.

The manufacturing process of the development roller 10 includes at least an adhesive application step and a flange press-fitting step. After the adhesive application step is performed, the flange press-fitting step is performed.

In the adhesive application step, the adhesive 5 is applied to the groove portion 43. The amount of adhesive 5 applied to the groove portion 43 is set to a volume which is equal to or greater than 40% and equal to or less than 100% of a space volume defined by the inner surface of the groove portion 43 and the inner circumferential surface of the sleeve 3.

In the flange press-fitting step, the fitting portion 40 is press-fitted into the sleeve 3 in a state where the adhesive 5 has been applied to the groove portion 43. Thereafter, the adhesive 5 is cured, and thus the sleeve 3 and the flange 4 are fixed. In this way, the fixation of the sleeve 3 and the flange 4 is ensured.

Here, the outer circumferential surface of the sleeve 3 serves as a surface on which the developer to be supplied to the electrostatic latent image on the outer circumferential surface of the photosensitive drum 111 is carried. In other words, the developer on the outer circumferential surface of the sleeve 3 is used to develop the electrostatic latent image into the toner image. Hence, when the adhesive 5 spills out on the outer circumferential surface of the sleeve 3, an image failure occurs. In order to suppress such an inconvenience, an adhesive removal step for removing the adhesive 5 from the outer circumferential surface of the sleeve 3 is needed. However, even when the adhesive removal step is added, it is likely that the adhesive 5 cannot be completely removed from the outer peripheral surface of the sleeve 3. Moreover, when the adhesive removal step is added, this leads to an increase in cost.

If the groove portion 43 is not provided in the fitting portion 40, the adhesive 5 crushed between the inner circumferential surface of the sleeve 3 and the outer circumferential surface of the fitting portion 40. Here, the adhesive 5 crushed between the inner circumferential surface of the sleeve 3 and the outer circumferential surface of the fitting portion 40 flows outward in the axial direction to spill out on the outer circumferential surface of the sleeve 3.

Hence, in the first embodiment, the groove portion 43 is provided in the fitting portion 40. The adhesive 5 remains in the groove 43. In this way, it is possible to suppress the spilling of the adhesive 5 out on the outer circumferential surface of the sleeve 3. Consequently, it is possible to suppress the occurrence of an image failure. Since the adhesive removal step is not needed, it is possible to suppress an increase in cost.

In the first embodiment, the amount of adhesive 5 applied is set to the volume which is equal to or greater than 40% and equal to or less than 100% of the space volume of the groove portion 43, and thus it is possible to reliably fix the sleeve 3 and the flange 4 using the adhesive 5 while suppressing the spilling of the adhesive 5 out on the outer circumferential surface of the sleeve 3.

For example, when the amount of adhesive 5 applied is excessively increased, the adhesive 5 easily spills out on the outer circumferential surface of the sleeve 3. On the other hand, when the amount of adhesive 5 applied is excessively decreased, the sleeve 3 and the flange 4 are insufficiently fixed using the adhesive 5. Hence, the amount of adhesive 5 applied is preferably set to the volume which is equal to or greater than 40% and equal to or less than 100% of the space volume of the groove portion 43.

In the first embodiment, an anaerobic adhesive is used as the adhesive 5. Hence, the height (corresponding to the height H12 in the first embodiment) from the lowest bottom surface of the groove portion 43 to the outer circumferential surfaces of the first support portion 41 and the second support portion 42 is set equal to or greater than 0.10 mm and equal to or less than 0.45 mm. In this way, it is possible to suppress the occurrence of an inconvenience in which a gap between the inner circumferential surface of the sleeve 3 and the lowest bottom surface of the groove portion 43 is excessively large to make it difficult to cure the adhesive 5.

In the first embodiment, the first groove portion 431 and the second groove portion 432 form the groove portion 43. The depth of the second groove portion 432 (corresponding to the height H12) is deeper than the depth of the first groove portion 431 (corresponding to the height H11). In this way, even when a part of the adhesive 5 flows from the first groove portion 431 outward in the axial direction, the adhesive 5 remains in the second groove portion 432. Consequently, the adhesive 5 is more unlikely to spill out on the outer circumferential surface of the sleeve 3.

### <4-2. Groove Portion in Second Embodiment>

In the second embodiment, as shown in FIGS. 9 to 11, the groove portion 43 includes a third groove portion 433 in addition to the first groove portion 431 and the second groove portion 432. In the first and second embodiments, the width of the groove portion 43 in the axial direction is the same, and the width of the first groove portion 431 in the axial direction is the same. On the other hand, the second embodiment differs from the first embodiment in that the third groove portion 433 is provided in the groove portion 43. The third groove portion 433 is provided in the groove portion 43, and the width of the second groove portion 432 in the axial direction in the second embodiment is less than the width of the second groove portion 432 in the axial direction in the first embodiment accordingly.

The first groove portion 431, the second groove portion 432 and the third groove portion 433 are continuously formed in this order from the side of the first support portion 41 (that is, the inward side in the axial direction) to the side of the second support portion 42 (that is, the outward side in the axial direction) in the axial direction. In other words, the first groove portion 431 is adjacent to the first support portion 41 in the axial direction on the inward side in the axial direction. The third groove portion 433 is adjacent to the second support portion 42 in the axial direction on the outward side in the axial direction. The second groove portion 432 is adjacent to the first groove portion 431 in the axial direction on the outward side in the axial direction. Furthermore, the second groove portion 432 is adjacent to the third groove portion 433 in the axial direction on the outward side in the axial direction.

In the second embodiment, as in the first embodiment, the height in the radial direction from the bottom surface of the groove portion 43 to the outer circumferential surfaces of the first support portion 41 and the second support portion 42 differs depending on the location. In the following description, it is assumed that the height in the radial direction from the bottom surface of the first groove portion 431 to the outer circumferential surfaces of the first support portion 41 and the second support portion 42 is H21, the height in the radial direction from the bottom surface of the second groove portion 432 to the outer circumferential surfaces of the first support portion 41 and the second support portion 42 is H22 and the height in the radial direction from the bottom surface of the third groove portion 433 to the outer circumferential surfaces of the first support portion 41 and the second support portion 42 is H23.

In the second embodiment, the groove portion 43 is formed such that the height H22 is higher than the height H21. The groove portion 43 is also formed such that the height H23 is the same as the height H21. In other words, a depth in the radial direction from the outer circumferential surfaces of the first support portion 41 and the second support portion 42 to the bottom surface of the second groove portion 432 (the depth corresponds to the height H22) is deeper than a depth in the radial direction from the outer circumferential surfaces of the first support portion 41 and the second support portion 42 to the bottom surface of the first groove portion 431 (the depth corresponds to the height H21). Moreover, the depth in the radial direction from the outer circumferential surfaces of the first support portion 41 and the second support portion 42 to the bottom surface of the second groove portion 432 (the depth corresponds to the height H22) is deeper than a depth in the radial direction from the outer circumferential surfaces of the first support portion 41 and the second support portion 42 to the bottom surface of the third groove portion 433 (the depth corresponds to the height H23). The height H23 may be higher than the height H21.

In the second embodiment, as in the first embodiment, an anaerobic adhesive is used as the adhesive 5, and thus the height from the lowest bottom surface of the groove portion 43 (that is, the deepest part of the groove portion 43) to the outer circumferential surfaces of the first support portion 41 and the second support portion 42 is set equal to or greater than 0.10 mm and equal to or less than 0.45 mm. Here, the deepest part of the groove portion 43 is the bottom surface of the second groove portion 432. Hence, the height H22 is equal to or greater than 0.10 mm and equal to or less than 0.45 mm.

The heights H21 and H23 in the second embodiment may be the same as the height H11 in the first embodiment. The height H22 in the second embodiment may be the same as the height H12 in the first embodiment.

In the second embodiment, as in the first embodiment, the groove portion 43 formed in the fitting portion 40, and the adhesive 5 is disposed in the groove portion 43. In the second embodiment, the development roller 10 is manufactured in the same steps as in the first embodiment.

In this way, in the second embodiment, it is possible to obtain the same effects as in the first embodiment. In other words, it is possible to reliably fix the sleeve 3 and the flange 4 using the adhesive 5 while suppressing the spilling of the adhesive 5 out on the outer circumferential surface of the sleeve 3.

In the second embodiment, as in the first embodiment, the height (corresponding to the height H22 in the second embodiment) from the lowest bottom surface of the groove portion 43 to the outer circumferential surfaces of the first support portion 41 and the second support portion 42 is set equal to or greater than 0.10 mm and equal to or less than 0.45 mm. In this way, although in the second embodiment, the same adhesive 5 (that is, an anaerobic adhesive) as in the first embodiment is used, it is possible to suppress a failure in the curing of the adhesive 5.

In the second embodiment, the first groove portion 431, the second groove portion 432 and the third groove portion 433 form the groove portion 43. The depth of the second groove portion 432 (corresponding to the height H22) is deeper than the depth of the first groove portion 431 (corresponding to the height H21). In this way, even when a part of the adhesive 5 flows from the first groove portion 431 outward in the axial direction, the adhesive 5 remains in the second groove portion 432. Consequently, the adhesive 5 is more unlikely to spill out on the outer circumferential surface of the sleeve 3.

Furthermore, in the second embodiment, the adhesive strength of the adhesive 5 can be ensured at two parts, that is, the part between the sleeve 3 and the first groove portion 431 and the part between the sleeve 3 and the third groove portion 433. In this way, as compared with the first embodiment, the fixation of the sleeve 3 and the flange 4 using the adhesive 5 can be secured.

### <4-3-1. Distance Between Both Ends of Support Portions>

In the following description, a distance in the axial direction from the end of the first support portion 41 on a side opposite to the side of the end opening 30 to the end of the second support portion 42 on the side of the end opening 30 is referred to as the “distance between both ends of the first support portion 41 and the second support portion 42”. The end of the first support portion 41 on the inward side in the axial direction corresponds to the end of the first support portion 41 on the side opposite to the side of the end opening 30, and the end of the second support portion 42 on the outward side in the axial direction corresponds to the end of the second support portion 42 on the side of the end opening 30.

In the first and second embodiments, the groove portion 43 is formed in the fitting portion 40. In other words, the groove portion 43 is formed between the first support portion 41 and the second support portion 42 in the axial direction. In this configuration, it is possible to suppress the spilling of the adhesive 5 out on the outer circumferential surface of the sleeve 3. However, when the distance between both ends of the first support portion 41 and the second support portion 42 is excessively decreased relative to the length of the sleeve 3 in the axial direction, the size of the part of the flange 4 which supports the sleeve 3 (part which is in contact with the inner circumferential surface of the sleeve 3) is decreased in the axial direction, and thus runout during the rotation of the sleeve 3 is increased. On the other hand, when the distance between both ends of the first support portion 41 and the second support portion 42 is unnecessarily and excessively increased relative to the length of the sleeve 3 in the axial direction, the size of the fitting portion 40 in the axial direction is increased, and thus a space for disposing the magnet 2 in the sleeve 3 is decreased.

Hence, in the first and second embodiments, when the accuracy of runout required during the rotation of the sleeve 3 is R (μm), the length of the sleeve 3 in the axial direction is L (mm), the distance between both ends of the first support portion 41 and the second support portion 42 is S (mm) and each of the outside diameters of the first support portion 41 and the second support portion 42 is D (mm), the following formula (1) is satisfied.

$$R > L / ( S \times D ) \times 1.9 \qquad ( 1 )$$

The accuracy of runout required during the rotation of the sleeve 3 corresponds a value which indicates how much the rotation axis of the sleeve 3 is displaced from an ideal rotation axis. For example, the development roller 10 is actually rotated, then the amount of displacement of the outer circumferential surface of the sleeve 3 in the radial direction is measured and thus it is possible to determine the accuracy of runout required during the rotation of the sleeve 3. The sleeve 3 with higher accuracy of runout has a lower degree of runout in the radial direction during the rotation, and thus the amount of displacement is decreased whereas the sleeve 3 with lower accuracy of runout has a higher degree of runout in the radial direction during the rotation, and thus the amount of displacement is increased. In other words, the sleeve 3 with higher accuracy of runout has a lower value of accuracy of runout whereas the sleeve 3 with lower accuracy of runout has a higher value of accuracy of runout.

The accuracy of runout required (tolerance) is predetermined by the manufacturer. The accuracy of runout required is 50 μm. In other words, the value of the R in the formula (1) described above is “50”.

The development roller 10 is configured to satisfy the formula (1) described above, and thus the accuracy of runout during the rotation of the sleeve 3 can be caused to fall within the tolerance. In other words, even when the groove portion 43 is formed in the fitting portion 40, as in a case where the groove portion 43 is not provided in the fitting portion 40, the accuracy of runout during the rotation of the sleeve 3 can be caused to fall within the tolerance. Furthermore, in other words, even when as compared with the case where the groove portion 43 is not provided in the fitting portion 40, the size of the part of the fitting portion 40 which supports the sleeve 3 (that is, the part which is in contact with the inner circumferential surface of the sleeve 3) is decreased, as long as the formula (1) described above is satisfied, the accuracy of runout during the rotation of the sleeve 3 can be caused to fall within the tolerance.

In this way, in the first and second embodiments, it is possible to suppress the runout during the rotation of the sleeve 3 while suppressing the spilling of the adhesive 5 out on the outer circumferential surface of the sleeve 3.

### <4-3-2. Confirmation Experiment>

An experiment which was performed to confirm the effects described above will be described below.

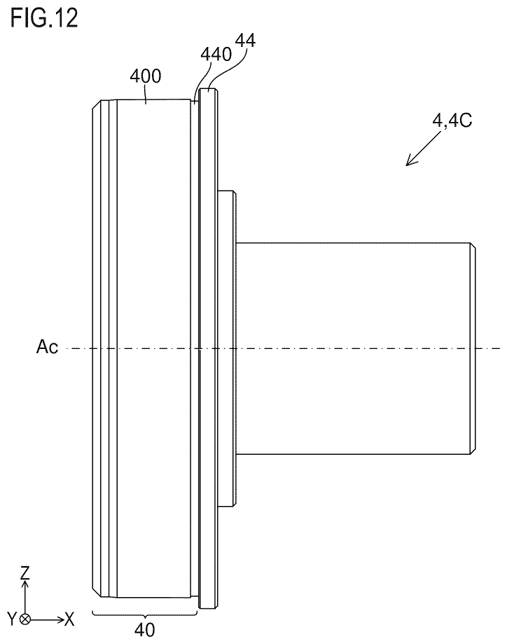

In Example 1, a flange 4A (see FIGS. 6 to 8) in the first embodiment was used. In Example 2, a flange 4B (see FIGS. 9 to 11) in the second embodiment was used. In Comparative Example, as the flange 4, a flange 4C shown in FIG. 12 was used.

In the flange 4C in Comparative Example, the groove portion 43 was not formed in the fitting portion 40. Specifically, the flange 4C in Comparative Example included, as a part which was in contact with the inner circumferential surface of the sleeve 3, a support portion 400 in which the groove portion 43 was not provided. The structure of the flange 4C in Comparative Example was the same as the structure of the flange 4A in the first embodiment except the structure described above.

The sleeves 3 in Examples 1 and 2 and Comparative Example were the same as each other. The length of the sleeve 3 was 233 mm. In other words, the value of the L in the formula (1) described above was “233”. The outside diameter of the sleeve 3 was 20 mm, and the inside diameter of the sleeve 3 was 18.4 mm.

The maximum outside diameter of each of the fitting portions 40 in Examples 1 and 2 and Comparative Example was 19 mm. In other words, the value of the D in the formula (1) described above was “19”. The width of each of the brim side groove portions 440 in the axial direction in Examples 1 and 2 and Comparative Example was 0.3 mm, and the depth of each of the brim side groove portions 440 was 0.05 mm.

In Example 1, the height H11 of the first groove portion 431 was 0.15 mm, and the height H12 of the second groove portion 432 was 0.25 mm. In Example 2, the height H21 of the first groove portion 431 was 0.15 mm, the height H22 of the second groove portion 432 was 0.35 mm and the height H23 of the third groove portion 433 was 0.15 mm.

In Example 1, the width of the first groove portion 431 in the axial direction w 0.8 mm, and the width of the second groove portion 432 in the axial direction was 0.7 mm. In Example 2, the width of the first groove portion 431 in the axial direction was 0.8 mm, the width of the second groove portion 432 in the axial direction was 0.35 mm and the width of the third groove portion 433 in the axial direction was 0.35 mm.

Here, in Example 1, the width of the first support portion 41 in the axial direction was 0.2 mm, and the width of the second support portion 42 in the axial direction was 0.3 mm. Hence, in Example 1, the distance between both ends of the first support portion 41 and the second support portion 42 was 2.0 mm (=0.2 mm+0.8 mm+0.7 mm+0.3 mm). In other words, in Example 1, the value of the S in

### The Formula (1) Described Above Was “2.0”.

In Example 2, as in Example 1, the width of the first support portion 41 in the axial direction was 0.2 mm, and the width of the second support portion 42 in the axial direction was 0.3 mm. Hence, in Example 2, as in Example 1, the distance between both ends of the first support portion 41 and the second support portion 42 was 2.0 mm (=0.2 mm+0.8 mm+0.35 mm+0.35 mm+0.3 mm). In other words, in Example 2, as in Example 1, the value of the S in the formula (1) described above was “2.0”.

In Examples 1 and 2, the outer circumferential surfaces of the first support portion 41 and the second support portion 42 in the fitting portion 40 were in contact with the inner circumferential surface of the sleeve 3. In other words, the first support portion 41 and the second support portion 42 supported the sleeve 3. In this way, in Examples 1 and 2, the length of the part of the fitting portion 40 in the axial direction which supported the sleeve 3 (hereinafter referred to as the support length in short) was 0.5 mm (=0.2 mm+0.3 mm).

On the other hand, in Comparative Example, the length of the support portion 400 in the axial direction was 2.0 mm. In this way, in Comparative Example, the total length of the part of the fitting portion 40 in the axial direction which supported the sleeve 3 (hereinafter referred to as the support length in short) was 2.0 mm. In other words, in Comparative Example, as compared with Examples 1 and 2, the groove portion 43 was not provided in the fitting portion 40, and the support length was long accordingly.

In each of Examples 1 and 2 and Comparative Example, two types of development rollers 10 which had different amounts of adhesive 5 applied to the fitting portion 40 were prepared. In one of the two types, the amount of adhesive 5 applied was 8 mg, and in the other, the amount of adhesive 5 applied was 4 mg. 8 mg of the amount of adhesive 5 applied corresponded to a volume which was 100% of the space volume of the groove portion 43, 4 mg of the amount of adhesive 5 applied corresponded to a volume which was 50% of the space volume of the groove portion 43.

Hereinafter, Example 1 where the amount of adhesive 5 applied to the fitting portion 40 was 8 mg is referred to as “Example 1 (8 mg)”. Example 1 where the amount of adhesive 5 applied to the fitting portion 40 was 4 mg is referred to as “Example 1 (4 mg)”. Example 2 where the amount of adhesive 5 applied to the fitting portion 40 was 8 mg is referred to as “Example 2 (8 mg)”. Example 2 where the amount of adhesive 5 applied to the fitting portion 40 was 4 mg is referred to as “Example 2 (4 mg)”. Comparative Example where the amount of adhesive 5 applied to the fitting portion 40 was 8 mg is referred to as “Comparative Example (8 mg)”. Comparative Example where the amount of adhesive 5 applied to the fitting portion 40 was 4 mg is referred to as “Comparative Example (4 mg)”.

In the confirmation experiment, a runout measurement was performed five times for each of Example 1 (8 mg), Example 1 (4 mg), Example 2 (8 mg), Example 2 (4 mg), Comparative Example (8 mg) and Comparative Example (4 mg). In the runout measurement, the accuracy of runout in three different points (a position F, a position C and a position R) of the sleeve 3 in the axial direction was measured. The position of the sleeve 3 on one end side in the axial direction was the position F, the position in the center in the axial direction was the position C and the position on the other end side in the axial direction was the position R. In the confirmation experiment, whether the adhesive 5 spilled out on the outer circumferential surface of the sleeve 3 was also checked.

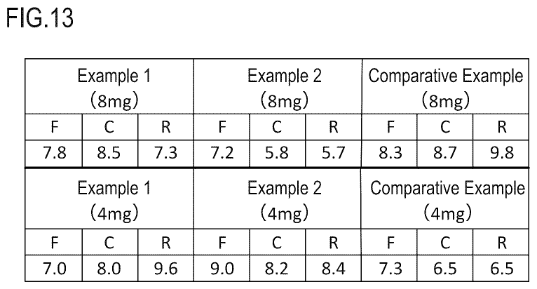

The results of the runout measurement are shown in FIG. 13. FIG. 13 shows the average values of the five measurements for each of Example 1 (8 mg), Example 1 (4 mg), Example 2 (8 mg), Example 2 (4 mg), Comparative Example (8 mg) and Comparative Example (4 mg).

In Comparative Example, the maximum value of the accuracy of runout was μm. On the other hand, in Example 1, the maximum value of the accuracy of runout was 9.6μm. In Example 2, the maximum value of the accuracy of runout was 9.0 μm.In other words, there was no significant difference in the accuracy of runout between Examples 1 and 2 and Comparative Example.

Here, in Comparative Example, a configuration was made to satisfy the formula (1) described above. Although in Examples 1 and 2, the groove portion 43 was formed in the fitting portion 40, configurations were made to satisfy the formula (1) described above. In each of Examples 1 and 2 and Comparative Example, L/(S×D)×1.9=11.65. L=233, S=2.0 and D=19. Since R=50, the formula (1) described above was satisfied.

Hence, it has been confirmed that even when the groove portion 43 is formed in the fitting portion 40, as long as the formula (1) described above is satisfied, the accuracy of runout during the rotation of the sleeve 3 is the same as the case where the groove portion is not provided in the fitting portion 40. In other words, it has been confirmed that the accuracy of runout during the rotation of the sleeve 3 falls within the tolerance.

In Comparative Example, the adhesive 5 spilled out on the outer circumferential surface of the sleeve 3. On the other hand, in Examples 1 and 2, the adhesive 5 did not spill out on the outer circumferential surface of the sleeve 3. This is considered to be because the adhesive 5 remained in the groove portion 43.

Therefore, it is said that as long as the formula (1) described above is satisfied, even when the groove portion 43 is formed in the fitting portion 40, the runout during the rotation of the sleeve 3 is suppressed. In other words, it is possible to suppress the runout during the rotation of the sleeve 3 while suppressing the spilling of the adhesive 5 out on the outer circumferential surface of the sleeve 3.

It should be considered that the embodiments disclosed herein are illustrative all respects, and not restrictive. The scope of the present disclosure is indicated not by the description of the above embodiments but by the scope of claims, and furthermore, meanings equivalent to the scope of claims and all changes in the scope are included therein.

What is claimed is:

1. A developer carrying member comprising:
a shaft that extends in a predetermined direction;
a magnet that is fixed to an outer circumferential surface of the shaft;
a sleeve that is cylindrical with the shaft being a center axis and carries a developer on an outer circumferential surface;
a flange that
is fixed to an end opening of the sleeve in the predetermined direction,
is rotatably supported to the shaft and
is rotated around the center axis together with the sleeve; and
an adhesive that bonds the sleeve and the flange,
wherein the flange includes a cylindrical fitting portion that is fitted into the sleeve through the end opening,
the fitting portion includes
a first support portion that is in contact with an inner circumferential surface of the sleeve,
a second support portion that
has a same outside diameter as an outside diameter of the first support portion, and
is in contact with the inner circumferential surface of the sleeve a position on a side of the end opening relative to the first support portion and
a groove portion that
is formed between the first support portion and the second support portion in the predetermined direction, and
is recessed in a radial direction relative to each of outer circumferential surfaces of the first support portion and the second support portion,
the adhesive is disposed in the groove portion and
when accuracy of runout required during rotation of the sleeve is R (μm), a length of the sleeve in the predetermined direction is L (mm), a distance in the predetermined direction from an end of the first support portion on a side opposite to the side of the end opening to an end of the second support portion on the side of the end opening is S (mm) and each of the outside diameters of the first support portion and the second support portion is D (mm), a value of the R is 50, and R>L/(S×D)×1.9 is satisfied.

2. The developer carrying member according to claim 1,
wherein the flange includes a brim portion that
is formed on the side of the end opening relative to the second support portion, and
protrudes in the radial direction beyond the fitting portion, and
in a state where the flange is fitted in the sleeve, an end surface of the sleeve in the predetermined direction is in contact with the brim portion.

3. The developer carrying member according to claim 2,
wherein the fitting portion includes a brim side groove portion that
is formed between the second support portion and the brim portion in the predetermined direction, and
is recessed in the radial direction relative to the outer circumferential surface of the second support portion, and
the brim portion forms one of inner side surfaces of the brim side groove portion in the predetermined direction.

4. The developer carrying member according to claim 1,
wherein the adhesive is an anaerobic adhesive, and
a height from a lowest bottom surface of the groove portion to the outer circumferential surfaces of the first support portion and the second support portion is equal to or greater than 0.10 mm and equal to or less than 0.45 mm.

5. The developer carrying member according to claim 1,
wherein the flange is made of aluminum.

6. The developer carrying member according to claim 1,
wherein the sleeve is made of aluminum.

7. A method for manufacturing the developer carrying member according to claim 1, the method comprising:
a step of applying the adhesive to the groove portion; and
a step of inserting the fitting portion into the sleeve through the end opening a state where the adhesive has been applied to the groove portion,
wherein each of the outside diameters of the first support portion and the second support portion is equal to or greater than an inside diameter of the sleeve before the fitting portion is inserted.

8. The method for manufacturing the developer carrying member according to claim 7,
wherein an amount of the adhesive applied to the groove portion is set to a volume that is equal to or greater than 40% and equal to or less than 100% of a space volume defined by an inner surface of the groove portion and the inner circumferential surface of the sleeve.
